(19) United States
(12) Patent Application Publication
(10) Pub. No.: US 2010/0037252 A1
(43) Pub. Date: Feb. 11, 2010

(54) Secured-tele-micro-browser for enabling internet browsing on a television

(76) Inventor: Ravikiran Pasupuleti Sureshbabu, Chennai (IN)

Correspondence Address: ALIX YALE & RISTAS LLP, 750 MAIN STREET, SUITE 1400, HARTFORD, CT, 06103, US

(21) Appl. No.: 12/462,604

(22) Filed: Aug. 5, 2009

(30) Foreign Application Priority Data
Aug. 6, 2008 (IN) 1886/CHE/2008

(51) Int. Cl. H04N 7/167; H04N 7/173

(52) U.S. Cl. 725/31; 725/110

(57) ABSTRACT

The present invention relates to a system for Secured-Tele-Micro-Browser (STMB) for secured Internet browsing on Television System based application. More particularly, the present invention relates to a STMB system and method for its implementation on Television systems to provide adequate security as well as selective signing in any internet site for desired communication and transaction. Advantageously, the present invention is directed to use Secured-Tele-Micro-Browser (STMB) using Conditional Access System (CAS) for secured communication, in particular for Television Commerce (t-commerce instead of computer/laptop based e-commerce) over a digital medium requiring a secured way of communication and other services and thus having wide acceptance to individual as well as corporate users.

### RELATED APPLICATION

This application claims priority under 35 U.S.C. 119(a) from Indian Patent Application No. 1886/CHE/2008 filed Aug. 6, 2008 for “A Secured-Tele-Micro-Browser For Enabling Internet Browsing On Television”, the entire disclosure of which is hereby incorporated by reference.

### FIELD OF THE INVENTION

The present invention relates to a system for Secured-Tele-Micro-Browser (STMB) for secured Internet browsing on Television System based application. More particularly, the STMB system and method for its implementation on Television systems is adapted to provide adequate security as well as selective signing in any internet site for desired communication and transaction, e.g. business/financial transaction with full browsing flexibility enabling simple, cost, effective and user-friendly yet secured content transmission over internet with TV interface at user end. The present approach reduces the complexity, and enables a wide range of STB's being able to have internet browsing capabilities in a secured manner for memory intensive application including an internet browser. Advantageously, the present invention is directed to use of Secured-Tele-Micro-Browser (STMB) using Conditional Access System (CAS) for secured communication, in particular for Television Commerce (t-commerce instead of computer/laptop based e-commerce) over a digital medium requiring a secured way of communication and other services and thus having wide acceptance to individual as well as corporate users.

### BACKGROUND ART

It is known in the art of telecommunication that the television programs have been broadcasted either through radio-frequency broadcasts, satellite downlink, or over coaxial cable television (CATV) network. It is also known in the field of data communication over network, such as Internet access, have been delivered via the telephone networks through dial-up connections, ISDN (Integrated Services Digital Network), and DSL (Digital Subscriber Line) lines or over hybrid broadcast/data CATV networks, where a portion of the bandwidth transmitted by the coaxial cable is allocated for shared data network functionality using a CSMA/CD-style transmission protocol. Less commonly, data connections to the home are provided via satellite links where data are downloaded via the satellite link and uploads are handled through landlines, such as the telephone network. Another technique is to transmit data to the home is through wireless or CDMA Links.

There has been a need for more ubiquitous computing model where the devices in the home having embedded systems designed for a particular function or purpose. To some extent CATV network set-top boxes (STB) typically have limited data communication capabilities. Their main function is to handle channel access issues between residential users and a server on the cable TV network.

There are numerous proprietary/Open source browsers available in the existing art which run from a Set Top Box (STB). These are full-fledged resident applications on the STB. However, the adoption of such browsers on STB's is not widespread. Set Top Boxes have very limited memory and processing resources, making it an incapable device/system for a memory intensive application like an internet browser.

An alternative approach is similar to a terminal server, where content rendering can happen at an intermediate server location, and only a snapshot of the rendered content is transmitted to the STB. This approach reduces the complexity, and enables a wide range of STB's being able to have Internet browsing capabilities. There are some providers who do provide such services but these are unable to provide desired security for confidential data transfer over an internet network using TV interface.

A number of attempts have been made in the past to resolve the aspect of accessing Internet facility over user-friendly low cost devices other than memory/processing intensive terminal computers.

U.S. Pat. No. 7,203,953 is a patent titled ‘Method and apparatus for two-way internet access over a CATV network with channel tracking’ states about 2-way communication over the CATV network, but is not indicative of its ability to provide exhaustive browsing facility particularly in TV based display system using STB.

U.S. Pat. No. 6,785,720 is a patent titled ‘Method for connecting to server devices in browser-based home network apparatus therefor’ and concerns the objective of controlling multiple devices at home using an embedded web server and web browser combination, unlike the simple TV based interface through STB using CAS as of the present invention.

U.S. Pat. No. 7,072,984 is a patent titled ‘System and method for accessing customized information over the internet using a browser for a plurality of electronic devices’ that states about internet browsing technology using markup languages (WML, XML) and delivering to mobile devices, home devices, etc. It neither uses a TV based interfacing nor does it indicate to use CAS network used by CATV operators for data communication/transaction in a secured manner.

U.S. Pat. No. 6,049,831 is a patent titled ‘System for transmitting network-related information where requested network information is separately transmitted as definitions and display information’ that disclosed means and method for separating the information from its presentation and decide the UI at runtime based on the target devices e.g. mobile, TV, PC etc.

U.S. Pat. No. 6,543,052 is a patent titled ‘Internet shopping system utilizing set top box and voice recognition’ that focuses on voice recognition as an input controlling mechanism to perform transactions on a television. It however is not indicative of security aspects in transactions and not indicative of full browsing facility using CAS.

U.S. Pat. No. 7,340,763 is a patent titled ‘Internet browsing from a television’ that states about using Optical character recognition technology to recognize internet content in a broadcast channel, for some level of interactivity.

U.S. Pat. No. 5,903,816 is a patent titled ‘Interactive television system and method for displaying web-like stills with hyperlinks’ that deals with making TV an interactive unit with video and web-like stills using the video.

The existing main limitations experienced in the art for widespread usage of Internet browsing from a TV are thus the following:
(a) Traditional Requirements: A full-fledged browser requires in the order of a few Mega Bytes of storage (FLASH memory) to reside and transient memory (RAM) to execute in a device.
(b) Security Dependencies: Enabling commercial/business transactions on a TV medium is not currently viable, as there are no mass-market low-cost hardware available to allow secured transactions through SSL as SSL is too resource intensive.

As a result, secured browsing on TV medium has not been explored to provide a commercially viable option. There has always been a big hurdle for mass-market approach. There has thus been a need in the art for commercially viable option to provide a secured full browsing capability on TV medium. The present invention provides such secured browsing in a TV medium to perform transaction in a secured manner to enable Commerce over a digital medium requiring a secured way of communication. The system and method of the invention focus on using CAS for secured communication for television commerce or t-commerce and other services.

### OBJECTS OF THE INVENTION

It is thus the basic object of the present invention to provide for a system for the secured data communication through Secured-Tele-Micro-Browser (STMB) on a Television based system to enable Secured Internet browsing.

A further object of the present invention is directed to providing said Secured-Tele-Micro-Browser (STMB) on a Television based system to enable Secured Internet browsing capability on a low-cost Set-Top Box (STB).

A still further object of the present invention is directed to developing a Secured-Tele-Micro-Browser (STMB) on a Television based system to enable Secured Internet browsing capability on a low-cost Set-Top Box (STB) wherein the system ensures security for Commerce over a digital medium by way of secured and reliable communication.

A still further object of the present invention is directed to developing a Secured-Tele-Micro-Browser (STMB) on a Television based system adapted to connect an existing two way Conditional Access System, i.e. a TV, with STB and a Head End Server of the TV channel service provider/operator.

A still further object of the present invention is directed to developing a Secured-Tele-Micro-Browser (STMB) on a Television based system to leverage the state-of-art encryption mechanisms of CAS system which is a closed network system to ensure security of communication/transactions and avoid piracy.

A still further object of the present invention is directed to developing a Secured-Tele-Micro-Browser (STMB) on a Television based system and yet ensuring secured communication between the STB and the server.

### SUMMARY OF THE INVENTION

Thus according to the basic aspect of the present invention there is provided a system for secured Tele-Micro-browser adapted for television based systems and the like for secured internet browsing comprising:
a Tele-Browser -Client (TBC) comprising a TV with Set-Top Box;
a Tele-Browser Server (TBS) comprising a head-end server of the TV Channel Service provider/Operator;
a Conditional Access System (CAS) operatively connected to provide a two way conditional access between the said TV with Set-Top Box and the said head-end server of the TV Channel Service provider/Operator to thereby provide for the desired secured internet browsing through said server at the said Tele-Browser client end.

Advantageously, the above system for secured Tele-Micro-browser adapted for television based systems and the like for secured internet browsing would favor TV based internet browsing capabilities on a low cost Set Top Box (STB).

Importantly, in the above system of the invention the said Tele-Browser-Client (TBC) is implemented into the Set-Top Box that is operatively connected to Tele-Browser Server (TBS).

In particular, the said Tele-Browser-Client (TBC) and said Tele-Browser Server (TBS) are adapted for allowing conditional access to the Tele-Browser-Client (TBC) for internet access via said Tele-Browser Server (TBS) through the existing Conditional Access System (CAS) between the said TV with Set-Top Box and the said head-end server of the TV Channel Service provider/Operator.

Advantageously, in the system of the invention the said TBC comprises a simple image renderer with minimal intelligence required to capture user keys from the STB remote.

The said TBS comprises a heavy server application adapted as a terminal server maintaining separate screen and session states for each TBC.

The said CAS system involved in the above system is thus adapted to initially exchange a secret-key for establishing the session between the TBC and the TBS and once this is done, this secret key is used for securely exchanging data from the TBC to TBS.

In accordance with another aspect of the invention there is provided a method of secured browsing on a TV and like medium using system as discussed above in accordance with the present invention comprising involving the Conditional Access System (CAS) operatively connected to provide a two way conditional access between the said TV with Set-Top Box and the said head-end server of the TV Channel Service provider/Operator to thereby provide for the desired secured internet browsing through said server at the said Tele-Browser client end.

The details of the invention, its objects and advantages are explained hereunder in greater detail in relation to non-limiting exemplary illustrations as per the following accompanying figures:

### BRIEF DESCRIPTION OF THE DRAWINGS

FIG. 1 is the schematic illustration of the Secured-Tele-Micro-Browser (STMB) on a Television based system for secured full Internet browsing provided through a set top box (STB) at client end according to the present invention receiving data communication with CAS based access to service provider through a head-end.

FIG. 2 is the schematic illustration of the Head-End at the CATV operator end of the Secured-Tele-Micro-Browser (STMB) on a Television based system, providing the Tele-Browser Server facility connecting client to internet over a CAS based communication channel/network interfaced with Internet network on TV.

### DETAILED DESCRIPTION

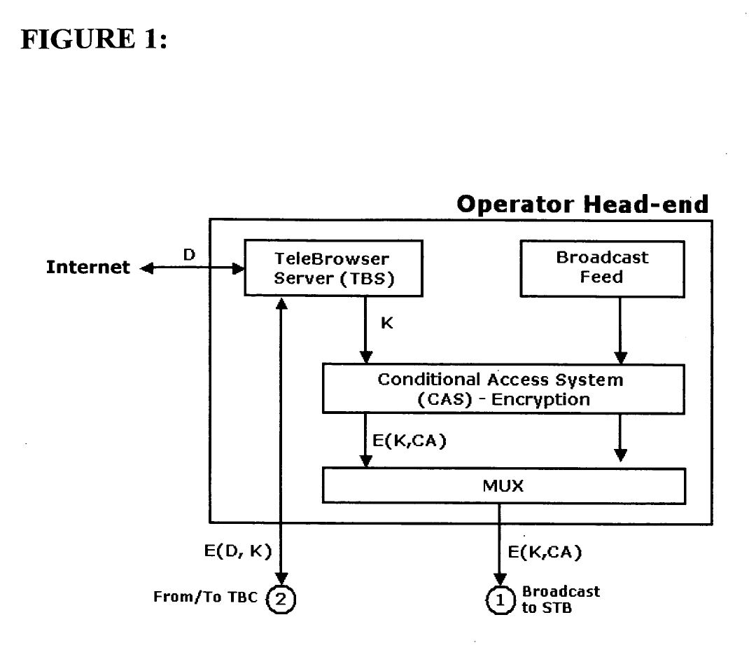

Reference is first invited to the accompanying FIG. 1 that schematically illustrates the Set Top Box at client end as part of the Secured-Tele-Micro-Browser (STMB) on a Television based system according to the invention for secured full Internet browsing accessible by individual user on a CAS based system. Such STB is connected to the Tele Browser of the CATV operator/service provider via Head-End unit at the CATV operator's end. It is apparent from the accompanying FIG. 1 that the STB of the present invention is adapted to receive connection to the host Tele Browsing server in a secured manner over the CAS network via its multi-user extension connection port. After a CAS based authentication is allowed to an end user, the resident tele-browser in the STB facilitates Internet access on TV through operative connectivity with the telebrowser server at the operator end.

The STMB of the present invention is adapted to connect an existing two way Conditional Access System (CAS), comprising a TV with Set-Top Box (STB) with the Head-end (Server) of the TV Channel Service Provider/Operator as described to provide full internet browsing facility with security. The system further ensures the leverage of the state-of-art encryption mechanisms of CAS system which is a closed network system for secured data communication and avoid piracy.

Advantageously according to the system of the invention, the Tele-Browser-Client (TBC) is implemented into the Set-Top Box that would connect to Tele-Browser Server (TBS) through the head-end at the service provider end. The TBC and TBS which are software components that are used to connect the systems such that the TBC functions as a simple image renderer with minimal intelligence required to capture user keys from the STB remote. Advantageously also, the TBS functions as a heavy server application that provides service as a terminal server maintaining separate screen and session states for each TBC.

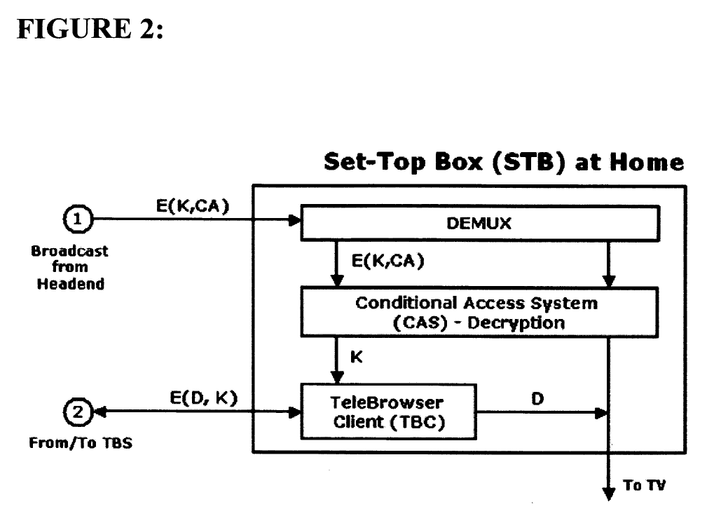

Reference is now invited to the accompanying FIG. 2 that schematically illustrates the arrangement of the Tele Browser Server (TBS) in the Head-End unit at the CATV operator end. It is clearly apparent from the accompanying FIG. 2 that the CAS network allows any access request from any user TV remote is authenticated for allowing access a or denial based on stored information with secret encryption so as to establish connection for each session with the STB at the client end. Once the connection is established, Internet access and full browsing is enabled via the Tele Browser Server (TBS) to the Tele-Browser-Client (TBC) enabling data communication/commerce in digital mode in a safe and secured manner using the TV screen as the interface interacting with the Internet based service provider. The Secured-Tele-Micro-Browser (STMB) on a Television based system of the present invention wherein a home TV with STB and Head-end features as described above is thus having the options to either access Internet or to connect to Broad cast feed or any audio-visual content send via CAS to the end user to be displayed on TV panel. The system and method of the present invention is thus capable of providing a secured data communication channel between internet service provider through the CATV operator and CAS system, at the TV user end for transacting business e.g. t-commerce or exchanging any confidential data/message communication with other end user via the internet framework in a safe, secured and reliable manner.

It is thus possible by way of the present invention to providing Secured-Tele-Micro-Browser (STMB) on a Television based system adapted to establish secured link via STB of home TV using the CAS based system offered by the CATBV operator/service provider. The system would provide a simple and less memory/processing intensive Tele-Browser-Client (TBC) resident at the STB adapted to enable full browsing facility to the end user via the Tele Browser Server (TBS) installed in the Head-End unit at the CATV operators end once a secured connection is established via CAS, using secret encryption key, to any requested site by an end user, such that secured data communication/commerce/transacting business in a simple, safe and secured manner using the TV as the interface.

We claim:

1. A system for secured Tele-Micro-browser adapted for television based systems and the like for secured internet browsing comprising:
a Tele-Browser -Client (TBC) comprising a TV with Set-Top Box;
a Tele-Browser Server (TBS) comprising a head-end server of the TV Channel Service provider/Operator; and
a Conditional Access System (CAS) operatively connected to provide a two way conditional access between the said TV with Set-Top Box and the said head-end server of the TV Channel Service provider/Operator to thereby provide for the desired secured internet browsing through said server at the said Tele-Browser client end.

2. The system for secured Tele-Micro-browser adapted for television based systems and the like for secured internet browsing according to claim 1 comprising TV based internet browsing capabilities on a low cost Set Top Box (STB).

3. The system for secured Tele-Micro-browser adapted for television based systems and the like for secured internet browsing according to claim 1 wherein said Tele-Browser-Client (TBC) is implemented into the Set-Top Box that is operatively connected to Tele-Browser Server (TBS).

4. The system for secured Tele-Micro-browser adapted for television based systems and the like for secured internet browsing according to claim 3 wherein said Tele-Browser-Client (TBC) and said Tele-Browser Server (TBS) are adapted for allowing conditional access to the Tele-Browser-Client (TBC) for internet access via said Tele-Browser Server (TBS) through the existing Conditional Access System (CAS) between the said TV with Set-Top Box and the said head-end server of the TV Channel Service provider/Operator.

5. The system for secured Tele-Micro-browser adapted for television based systems and the like for secured internet browsing according to claim 4 wherein said CAS system is adapted to initially exchange a secret-key for establishing the session between the TBC and the TBS and once this is done, this secret key is used for securely exchanging data from the TBC to TBS.

6. The system for secured Tele-Micro-browser adapted for television based systems and the like for secured internet browsing according to claim 5, wherein said TBC comprises a simple image renderer with minimal intelligence required to capture user keys from the STB remote.

7. The system for secured Tele-Micro-browser adapted for television based systems and the like for secured internet browsing according to claim 5 wherein said TBS comprises a heavy server application adapted as a terminal server maintaining separate screen and session states for each TBC.

8. A method of secured browsing on a TV and like medium comprising involving the Conditional Access System (CAS) operatively connected to provide a two way conditional access between the said TV with Set-Top Box and the said head-end server of the TV Channel Service provider/Operator to thereby provide for the desired secured internet browsing through said server at the said Tele-Browser client end.
